(19) United States
(12) Patent Application Publication
(10) Pub. No.: US 2010/0013727 A1
(43) Pub. Date: Jan. 21, 2010

(54) LNB Alignment Device for Positioning Satellite Dish Feed Horns and Method Therefor

(76) Inventors: Daniel Pifer, Wayne, NY (US); Royce Pifer, Bath, NY (US)

Correspondence Address: LAW OFFICE OF TRACY P. JONG, 2775 BUFFALO ROAD, SUITE 3, ROCHESTER, NY, 14624, US

(21) Appl. No.: 12/504,634

(22) Filed: Jul. 16, 2009

Related U.S. Application Data
(60) Provisional application No. 61/081,506, filed on Jul. 17, 2008.

(51) Int. Cl. H01Q 13/00

(52) U.S. Cl. 343/779; 343/781 R

(57) ABSTRACT

There is disclosed an LNB alignment device having a main body that removably attaches to a support arm of a satellite dish and has a plurality of mounting holes or rectangular sleeves configured to receive a plurality of low-noise block converters with feed horns (LNBs). The proximal and distal ends of the bar curve inwardly toward the satellite dish and curve slightly upward in a manner that the feed horns of LNBs outside of the focal axis are disposed higher and closer to the center of the reflector to improve signal quality.

### CROSS REFERENCE TO RELATED APPLICATIONS AND PRIORITY CLAIM

This application claims the benefit of priority from provisional patent application 61/081,506 entitled “LNB Alignment Device for Positioning Satellite Dish Feed Horns” and filed on Jul. 17, 2008.

### FIELD OF THE INVENTION

This invention relates generally to satellite dish antennas, and more particularly, to an LNB alignment device which positions feed horns about the reflector of a satellite dish antenna.

### BACKGROUND OF THE INVENTION

There are many alignment devices available to mount feed horns to a satellite dish to improve or change satellite signal reception. While some of these prior art alignment devices have gained popularity, they are not capable of allowing an installer to optimally position one or more feed horns which are more than ten degrees from the focal axis at predetermined focal points about a satellite dish. As used in this specification, the term “focal axis” means a focal axis according to the teachings of U.S. Pat. No. 4,407,001. Said disclosure is incorporated by reference in its entirety.

In order to overcome the bandwidth limitations of a single satellite, many direct broadcast satellite systems make use of multiple geostationary satellites. One means to receive signals from multiple satellites in such a system is to use a separate satellite dish antenna (“satellite dish”) for each of the satellite signals to be received. Drawbacks of this approach include the cost of multiple satellite dishes, the extra time required to install these multiple satellite dishes, and the awkward appearance of such an arrangement.

A more convenient means to receive signals from multiple satellites is to use a multi-satellite dish consisting of a reflector and a feed horn positioned along or near the focal axis of the reflector for each satellite from which signals are to be received.

The majority of satellite dishes can be modified to accommodate a different number and positioning of feed horns about the reflector of a satellite dish antenna. Satellite dish adapter devices (“adapter devices”) can allow an installer to modify an existing satellite dish to receive a greater number or different group of satellites. This in turn can lower the cost to convert equipment to work with a different direct broadcast satellite system or to receive additional programming from a direct broadcast satellite system.

Conventional multi-satellite dishes which use original equipment alignment devices (“original equipment”) and most adapter devices position multiple feed horns along a straight line that intersects and is perpendicular to the focal axis of the reflector. The result of this is that feed horns near the focal axis can receive satellite signals with acceptable signal quality; however feed horns farther from the focal axis will not receive satellite signals with acceptable quality.

When using the previously mentioned original equipment and most adapter devices, receiving satellite signals from geostationary locations greater than 20 degrees apart results in a significant loss in signal quality and requires fine tuning the orientation of the satellite dish. This 20 degree limitation means that when using the most common feed horn units, a maximum of three feed horns will fit side-by-side in front of a satellite dish. This in turn limits a multi-satellite dish to receiving signals from three satellites or requires the use of more expensive feed horn units. Direct broadcast satellite systems are similarly limited to using three satellites or to opt for the use of more dishes or more expensive feed horn units.

Some original equipment diverges slightly from the pattern of positioning multiple feed horns along a straight line that intersects and is perpendicular to the focal axis of the reflector; however, this original equipment is still limited to receiving satellite signals from geostationary locations no greater than about 20 degrees apart.

Some adapter devices allow feed horns to be positioned nearly anywhere in front of the reflector of a satellite dish which can allow feed horns which are far from the focal axis to receive satellite signals with acceptable signal quality. Such devices are large compared to other adapter devices, are only suitable for larger dishes and cast a relatively large shadow on any dish. The most significant drawback of such devices is that they do not indicate preferred positions for feed horns, and thus positioning feed horns can be very difficult and time consuming

There is none presently known that addresses the preceding problems. Thus, it is desirable to design an LNB alignment device for satellite dishes that fulfills this need and others.

### SUMMARY OF THE INVENTION

The LNB alignment device of the present invention comprises a main body to position LNB feed horns about the reflector of a satellite dish, wherein the main body has a plurality of receptacles (e.g., mounting holes, sleeves, or clamps) for positioning one or more LNB feed horns, wherein the proximal and distal ends of the main body curve inwardly toward the reflector of the satellite dish and curve slightly upward, and wherein all LNB feed horns aim within 20 degrees of the center of the reflector.

The present invention positions LNB feed horns about the reflector of a satellite dish so that the two outer most LNB feed horns outside of the focal axis are disposed so that a line between them (“level line”) is within 10 degrees of parallel with the satellite dish's x-axis. The present invention positions LNB feed horns (“feed horns”) about the reflector of a satellite dish so that the feed horn opening is along a curve which opens toward the reflector, is disposed 60% to 160% the focal length of the reflector away from the center or vertex of the reflector, and whose radius of curvature is 30% to 630% the focal length of the reflector. The present invention positions feed horns about the reflector of a satellite dish so that feed horns outside of the focal axis are held at the same height or progressively higher along an upward curve. The focal points for feed horns outside of the focal axis are disposed along the inward and upward curves, thus enhancing signal quality of the reception. Prior art holds feed horns in a straight line which cannot place feed horns which are outside of the focal axis in the necessary focal points.

In another embodiment, the main body attaches directly to the reflector of the satellite dish. This is useful in the case of satellite dishes which have a weak support arm or a support arm that does not allow a bar like member to be easily bolted to it.

In another embodiment, the LNB alignment device is a unitary device comprising the main body and permanently affixed LNB feed horns disposed thereabout, that attaches to the support arm of an existing satellite dish, positioning feed horns as described above. This embodiment requires very little setup work and is ideal for a one-time conversion of an existing satellite dish.

It is an object of the present invention to provide an LNB alignment device that positions LNB feed horns about the reflector of a satellite dish so that feed horns outside of the focal axis are disposed closer to the center of the reflector than conventional devices.

It is an object of the present invention to provide an LNB alignment device that positions LNB feed horns about the reflector of a satellite dish that allows a user to set a feed horn at a plurality of predetermined focal points and/or angles.

It is an object of the present invention to provide an LNB alignment device that positions LNB feed horns about the reflector of a satellite dish so that feed horns outside of the focal axis are disposed higher than conventional devices.

It is an object of the present invention to provide an LNB alignment device that positions LNB feed horns about the reflector of a satellite dish so that all feed horns aim closer to the center of the reflector than conventional devices.

It is a further object of the present invention to provide an LNB alignment device that is versatile and readily adaptable to different applications for a satellite dish user or installer.

It is a further object of the present invention to provide an LNB alignment device that is simple to make and of light weight, so that it can be easily manufactured and used by amateur and professional satellite installers.

It is yet another object of this invention to provide a relatively simple LNB alignment device that is economical for mass production from the viewpoint of the manufacturer and consumer, thereby making it economically available to the buying public.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

In this respect, before explaining at least one embodiment of the invention in detail, it is to be understood that the invention is not limited in its application to the details of construction and the arrangements of the components set forth in the following description or illustrated in the drawings. The present invention is capable of other embodiments and of being practiced and carried out in various ways. Also it is to be understood that the phraseology and terminology employed herein are for the purpose of description and should not be regarded as limiting.

### PARTICULAR ADVANTAGES OF THE INVENTION

The LNB Alignment Device disposes feed horns outside of the focal axis progressively higher along an upward and inward curve, thereby providing enhanced signal quality of reception for feed horns outside the focal axis and allowing a satellite dish to receive satellite signals from geostationary locations greater than 20 degrees longitude apart. The design of the main body allows the LNB alignment device to receive signals from more than 5 orbital locations and from orbital locations greater than 20 degrees longitude apart. This is previously unknown in the art for unitary LNB alignment devices and the signal quality is achieved is unknown for non-unitary LNB alignment devices.

The LNB Alignment Device aligns the feed horns progressively higher along an upward and inward curve, thereby allowing more than three feed horns to fit side-by-side in front of a satellite dish while maintaining acceptable signal quality,

The LNB Alignment Device provides a compact and easy to install device that is suitable for smaller satellite dishes, does not cast a large shadow on the dish and indicates preferred positions for feed horns, thereby allowing a user to easily position feed horns in an optimal configuration.

### BRIEF DESCRIPTION OF THE DRAWINGS

The invention will be described by reference to the specification and the drawings, in which like numerals refer to like elements, and wherein:

FIG. 1 is a perspective view of an LNB alignment device of the present invention;

FIG. 2 is a perspective view of the LNB alignment device depicted in FIG. 1 as mounted to a support arm of a satellite dish without a yoke;

FIG. 3 is a perspective view of the LNB alignment device depicted in FIG. 1 as mounted to a support arm of a satellite dish with a yoke;

FIG. 4 is a top view of the LNB alignment device depicted in FIG. 1 mounted to a support arm of a satellite dish;

FIG. 5 is an orthogonal side view of the LNB alignment device mounted to a support arm of a satellite dish;

FIG. 6 is an orthogonal front view of the LNB alignment device mounted to a support arm of a satellite dish;

FIG. 7 is a perspective view of the LNB alignment device depicted in FIG. 1 with six LNBs mounted to a support arm of a satellite dish;

FIG. 8 is a perspective view of the back of a Low Noise Block with Feed Horn (LNB);

FIG. 9 is a perspective view of the front of an LNB;

FIG. 10 is a side view of an LNB;

FIG. 11 is a side view of an LNB with a main body cross section;

FIG. 12 is a perspective view of a satellite dish reflector and support arm.

FIG. 13 is a perspective view of an alternate embodiment of an LNB alignment device which uses slidable LNB neck clamps and is mounted to a support arm of a satellite dish;

FIG. 14 is a perspective view of an alternate embodiment of an LNB alignment device which uses slidable LNB neck clamps and is holding LNBs;

FIG. 15 is a perspective view of a slidable LNB neck clamp fastened to an LNB;

FIG. 16 is a side view of slidable LNB neck clamp fastened to an LNB with a main body cross section;

FIG. 17 is a perspective view of an alternate embodiment of an LNB alignment device which uses mounting holes and is mounted to a support arm of a satellite dish;

FIG. 18 is a perspective view of an alternate embodiment of an LNB alignment device which uses mounting holes and is mounted to a support arm of a satellite dish and holding LNBs;

FIG. 19 is a perspective view of an alternate embodiment of an LNB alignment device which uses mounting slots and is mounted to a support arm of a satellite dish;

FIG. 20 is a perspective view of an alternate embodiment of an LNB alignment device mounted to a support arm of a satellite dish with LNBs fastened to the mounting slots;

FIG. 21 is a side view of an LNB with a main body cross section;

FIG. 22 is a perspective view of an alternate embodiment of an LNB alignment device which uses LNB base sleeves and is mounted to a support arm of a satellite dish;

FIG. 23 is a perspective view of an alternate embodiment of an LNB alignment device mounted to a support arm of a satellite dish with LNBs fastened in the LNB base sleeves;

FIG. 24 is a perspective view of an alternate embodiment of an LNB alignment device which uses fixed LNB neck clamps and is mounted to a support arm of a satellite dish;

FIG. 25 is a perspective view of an alternate embodiment of an LNB alignment device mounted to a support arm of a satellite dish with LNBs fastened in the fixed LNB neck clamps;

FIG. 26 is a perspective view of a fixed LNB neck clamp fastened to an LNB;

FIG. 27 is a side view of a fixed LNB neck clamp fastened to an LNB;

FIG. 28 is a perspective view of an alternate embodiment of an LNB alignment device combined with LNBs into a unit and mounted to a support arm of a satellite dish;

FIG. 29 is a perspective view of a paraboloid reflector and the larger paraboloid that it is part of.

FIG. 30 is a perspective view of a paraboloid reflector with the reflector's center point and focal axis.

FIG. 31 is a perspective view of a receiver paraboloid.

FIG. 32 is a perspective view of a paraboloid reflector with source and resultant lines and vectors.

FIG. 33 is a perspective view of a receiver paraboloid with resultant line and receiver point.

FIG. 34 is a perspective view of a paraboloid reflector with resultant lines and receiver points.

FIG. 35 is a perspective view of a receiver paraboloid with resultant lines and receiver points.

FIG. 36 is a perspective view of a feed horn.

FIG. 37 is a side view of a feed horn.

FIG. 38 is a perspective view of a paraboloid reflector with feed horns at several receiver points.

FIG. 39 is a perspective view of an LNB showing the position of its internal feed horn.

FIG. 40 is a side view of an LNB showing the position of its internal feed horn.

FIG. 41 is a perspective view of a feed horn curve and feed horn plane intersecting a receiver paraboloid.

The drawings are not to scale, in fact, some aspects have been emphasized for a better illustration and understanding of the written description.

### PARTS LIST

4 feed horn opening point
12 Low Noise Block converter with Feed Horn (LNB)
20 LNB alignment device
30 paraboloid reflector (reflector)
32 receiver support arm (support arm)
40 first end of the main body
42 second end of the main body
44 interior portion of the main body
46 another interior portion of the main body
48 middle of the main body
60 LNB neck
62 y axis
64 x axis
66 z axis
108 main body
112 yoke
114 sloped component
116 fixed LNB neck clamp
118 origin of the coordinate system (origin)
120 reflector's paraboloid
122 vertex of the reflector's paraboloid
124 focus of the reflector's paraboloid
126 reflector's center point
130 receiver paraboloid
132 vertex of the receiver paraboloid
134 source line
136 source vector
138 resultant vector
140 resultant line
142 receiver point
144 feed horn curve
146 feed horn plane
148 intersection of the feed horn plane with the xz-plane
150 receiver point A
152 receiver point B
160 main body cross section
162 slidable LNB neck clamp
164 mounting hole
166 mounting slot
168 mounting slot break
170 LNB base sleeve
172 support arm sleeve
174 main body riser
180 LNB's base
182 LNB's mounting hole
190 feed horn
192 feed cone
194 waveguide
196 feed throat
198 feed throat center
200 feed horn's negative z-axis
202 feed horn's positive z-axis

### DETAILED DESCRIPTION OF A PREFERRED EMBODIMENT

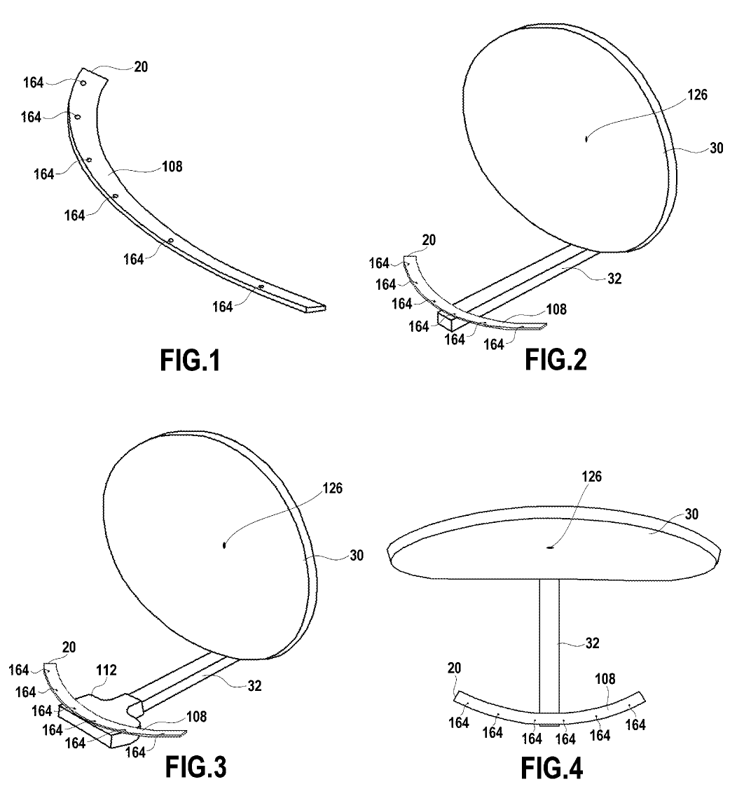

FIG. 1 depicts a perspective view of an LNB alignment device of the present invention. Referring to FIG. 1, the LNB alignment device 20 comprises a main body 108 formed of a metal bar that removably attaches to a support arm of a satellite dish and having a plurality of receptacles (e.g., mounting holes, rectangular sleeves or circular clamps) configured to receive a plurality of low-noise block converters with feed horns (LNBs). FIG. 1 depicts the main body of an LNB alignment device 20 that is designed to hold six rectangular-base LNBs or LNBs with dome-shaped bases in its receptacles. In the embodiment depicted, the receptacles are formed as simple mounting holes 164. Each mounting hole is at a predetermined position to place an LNB's feed horn opening in the focal area of a satellite signal from a geostationary location.

FIG. 2 depicts the LNB alignment device as mounted to a support arm of a satellite dish without a yoke. The main body of an LNB alignment device 20 is mounted on a support arm 32 along with the reflector 30. FIG. 3 depicts the LNB alignment device as mounted to a support arm of a satellite dish with a yoke 112 which attaches to the support arm 32. As will be apparent to those skilled in the art, the LNB alignment device has many embodiments and configurations to suit nearly any satellite dish arrangement and size. In fact, the LNB alignment device may be used with any paraboloid receiver and is not limited to satellite dish receivers in its application. The device and method of optimally aligning the receivers to receive signals with the least distortion and interference has applications in a number of areas outside television signal reception such as, for example, wireless networking antennas.

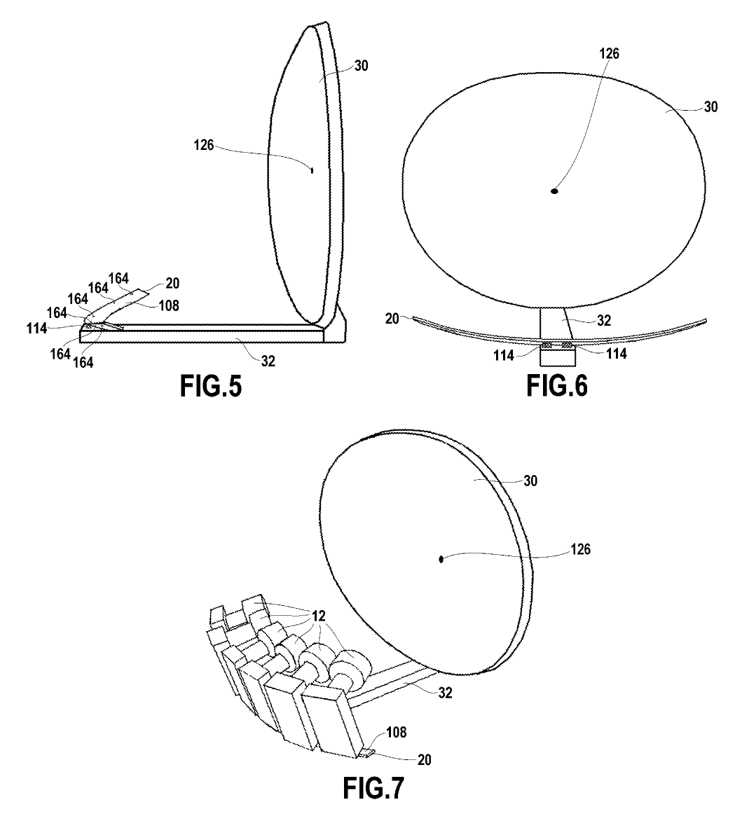

FIG. 4 is a top view of the LNB alignment device mounted to a support arm of a satellite dish that clearly depicts its curve inward and the placement of the mounting holes 164. FIG. 5 is an orthogonal side view of the LNB alignment device mounted to a support arm of a satellite dish that clearly depicts its curve upward. FIG. 6 is an orthogonal front view of the LNB alignment device 20 mounted to a support arm of a satellite dish. Two sloped washers 114 are provided as a means to hold the LNB alignment device 20 at an angle with the LNB support arm 32. In this aspect in FIG. 5, the support arm 32 is flat and requires a sloped washer between the main body and the support arm 32 to act as the sloped component 114. In other arrangements, it is to be appreciated that the sloped component may be formed by something other than a sloped washer, such as, for example, a contour of the support arm, a separate piece, or the like.

FIG. 7 is a perspective view depicting an embodiment of the LNB alignment device 20 holding six rectangular-based LNBs 12. It is preferable if the LNB alignment device 20 positions the outermost LNBs so that a line between them (“level line”) is within 10 degrees, and more preferably within 5 degrees, of parallel with the satellite dish's x-axis. It is most preferable if the level line is parallel with the dish's x-axis as set forth in greater detail below.

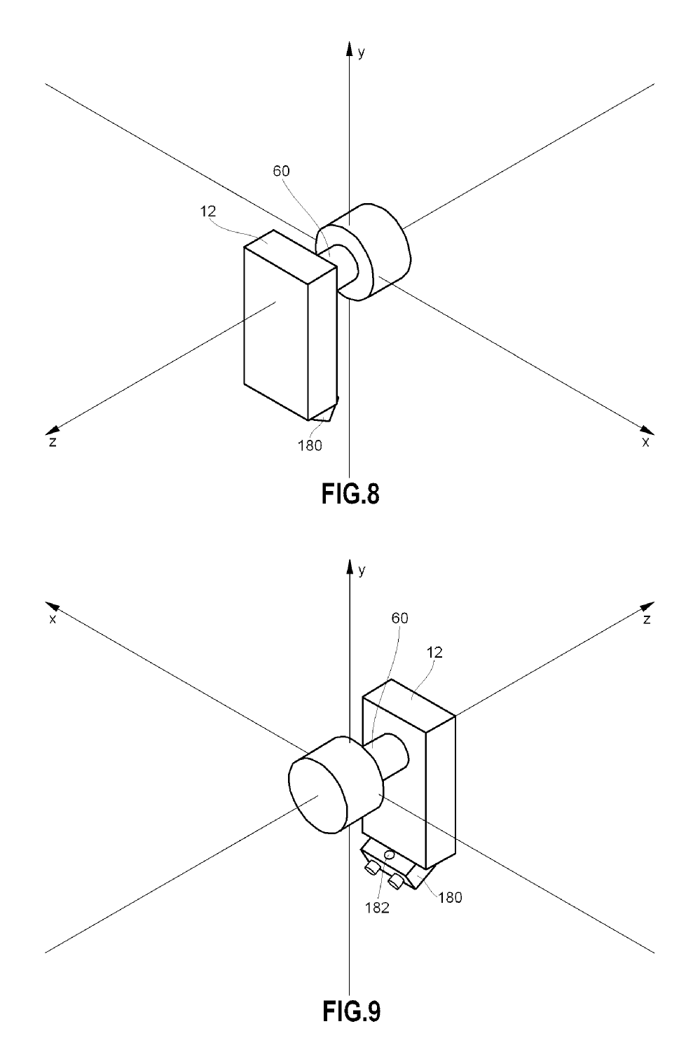

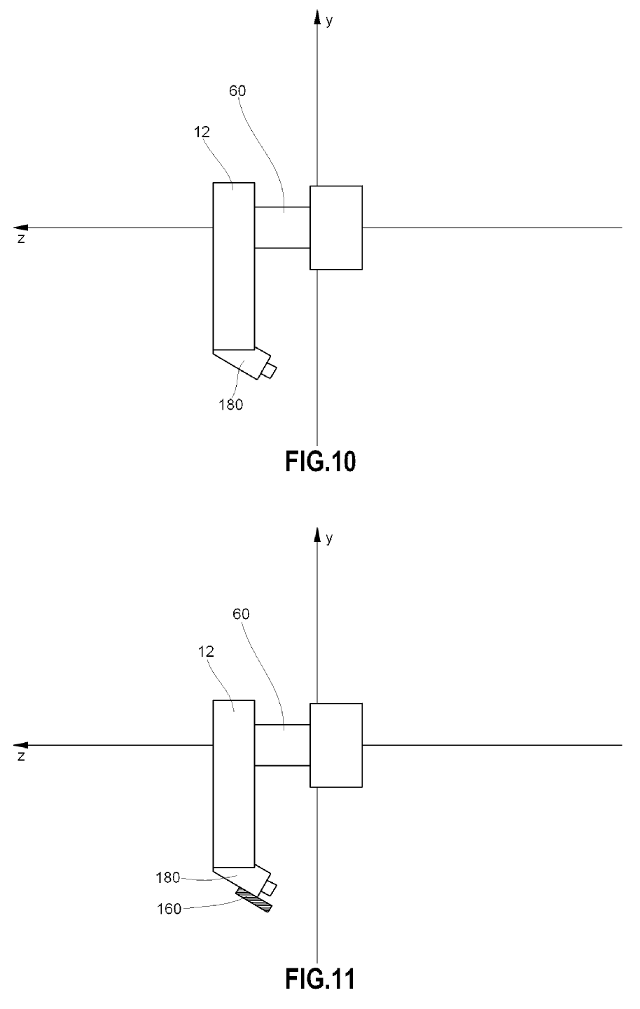

FIG. 8 is a perspective view of the back of a Low Noise Block with Feed Horn (LNB). As depicted, an LNB generally comprises a LNB neck 60 and LNB base 180. FIG. 9 is a perspective view of the front of an LNB. As more clearly shown in FIG. 9, the mounting hole for fastening the LNB to the LNB alignment device is disposed on the LNB base. FIG. 10 is a side view of an LNB.

As illustrated in FIGS. 1 through 7, LNBs are attached to the LNB alignment device in predetermined locations and LNBs outside of the focal axis of the reflector are rotated to generally aim at the center 126 of the reflector. LNBs outside of the focal axis of the reflector are held at a uniform distance from the reflector's center 126 (thus creating an inward curve) and are disposed progressively higher (thus creating a curve upward). These inward and upward curves are important to optimal signal quality because the LNB's feed horn opening is optimally disposed in the focal area of a satellite signal from a geostationary orbital location. Since the feed horn openings are lower than the center 126 of the reflector, part of the upward curve is a component of the feed horn openings curving toward the reflector's center 126. When a satellite dish is aligned with a given geostationary orbital location (“aim location”), geostationary orbital locations to the east and west appear progressively lower from the reflector's perspective. When these lower signal sources reflect off of the reflector, they cause focal areas which are progressively higher than the focal point created by the center point 126. This is the other part of the upward curve.

The design of the main body allows the LNB alignment device 20 to receive signals from more than 5 orbital locations and from orbital locations greater than 20 degrees longitude apart. This is previously unknown in the art for unitary LNB alignment devices and the signal quality achieved is unknown for non-unitary LNB alignment devices. A level line between the two outer most LNB feed horns which passes through the center of the LNBs' feed horns is preferably within 5 degrees of parallel with the dish's x-axis, and it is preferred if the level line is parallel with the dish's x-axis. In one aspect of this embodiment, the dimensions of the main body are calculated for a specific geographic location.

The present invention preferably positions the LNB feed horns about the satellite dish so that the feed horn opening is along a curve which opens toward the reflector, is disposed 60% to 160% the focal length of the reflector away from the vertex or center of the reflector, and Whose radius of curvature is 30% to 630% the focal length of the reflector.

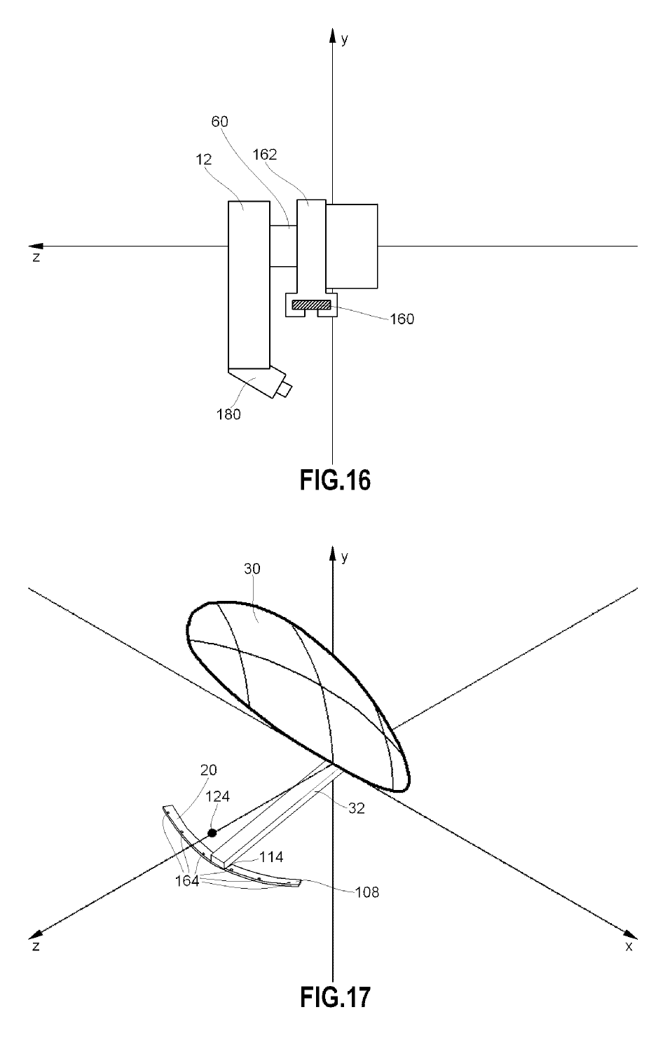

The shape and dimensions of the main body 108 are preferably determined by sliding the LNB and its main body cross section 160 (depicted in FIGS. 11 and 16) along the feed horn curve as described in “Method to Define a Main Body Using a Feed Horn Curve.” The feed horn curve is found using “Method to Define a Feed Horn Curve for Multiple Movable Feed Horns” described in greater detail below. It is preferable to position each LNB and its corresponding mounting hole by using the “Method to Position One LNB Along the Feed Horn Curve” described in greater detail below.

The LNB alignment device 20 may provide for selectively adjustable feed horn 12 placement or may provided predetermined fixed mounting receptacle 164 locations on the main body 108. Several embodiments providing for each of these types will be described as illustrative of the concepts of the present invention. The adjustability of the feed horns is to position an opening of the feed horns along a curve. The receptacles cooperate with an adjustable attachment mechanism of the low-noise block converters with feed horns such that the feed horns are adjustable in a manner to position an opening of the feed horns along a curve. The adjustable attachment mechanism may take many forms, some of which are illustrated in the drawings. These include, but are not limited to, neck clamps that are slideable along the main body, a slot receptacle in the main body that cooperates with a bolt (or other commonly known means of attachment) to the LNB, or a cooperating arrangement between a sleeve receptacle and the LNB base that offers the flexibility to rotate and position the feed horns as desired.

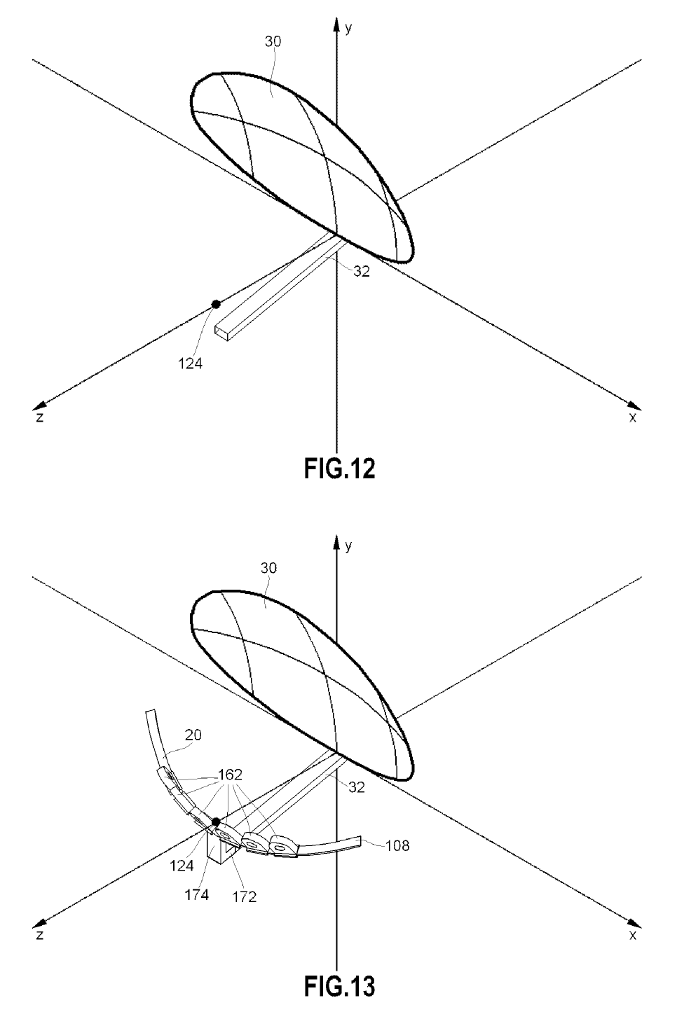

FIG. 12 depicts a satellite dish paraboloid reflector 30 and a support arm 32. Point 124 is the focus of the reflector. As can be seen is this drawing, the LNB alignment device is most often mounted to the support arm, but this is not required.

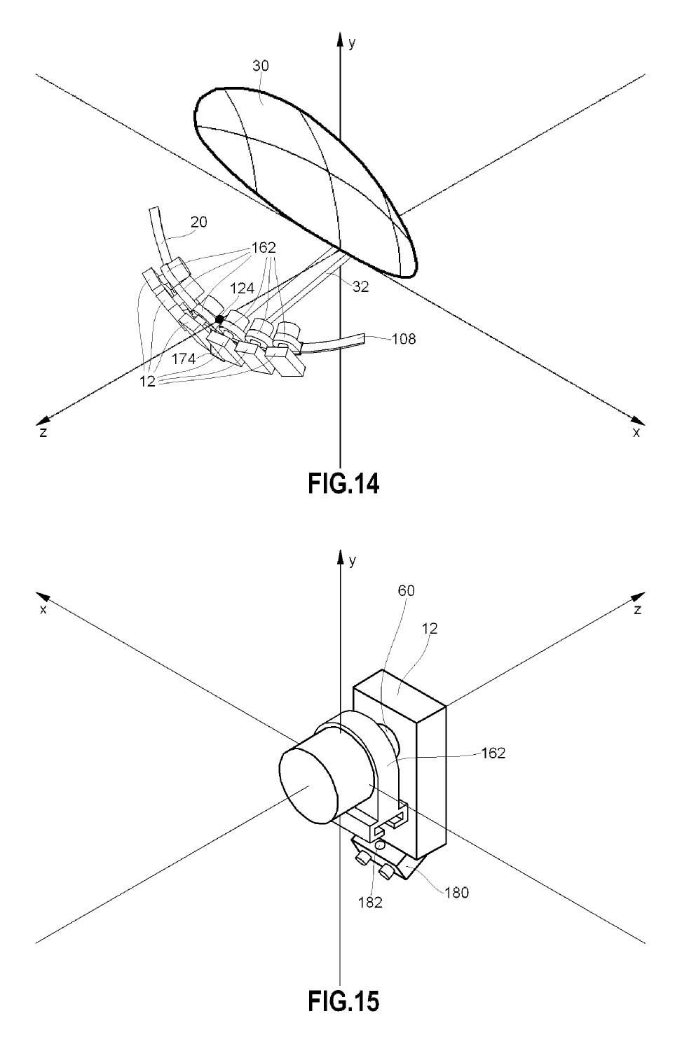

FIG. 13 depicts the main body of an LNB alignment device 20 with moveable (e.g., slidable) neck clamps 162, shown in greater detail in FIGS. 15 and 16, which are designed to hold the necks of LNBs. The support arm sleeve 172 fastens over the support arm 32. The main body riser 174 elevates the main body 108 above the support arm sleeve. The slidable neck clamps near the support arm are generally near the focus of the reflector's paraboloid 124. FIG. 14 depicts the same alignment device with LNBs fastened in place by the moveable neck clamps 162.

FIG. 15 more clearly shows a slidable neck clamp 162 attached to an LNB neck 60. The slidable neck clamp does not make use of or require an LNB to have a base 180 or mounting hole 182. The z-axis of the LNB goes through the center of the feed horn that it contains. The negative z-axis will generally aim toward the center of a satellite dish reflector. The y-axis is the vertical axis of the LNB while the x-axis is the horizontal axis of the LNB. FIG. 16 is a side view of a slidable neck clamp 162 attached to an LNB neck 60. The LNB's base 180 is not used. The slidable neck clamp requires the main body cross section 160.

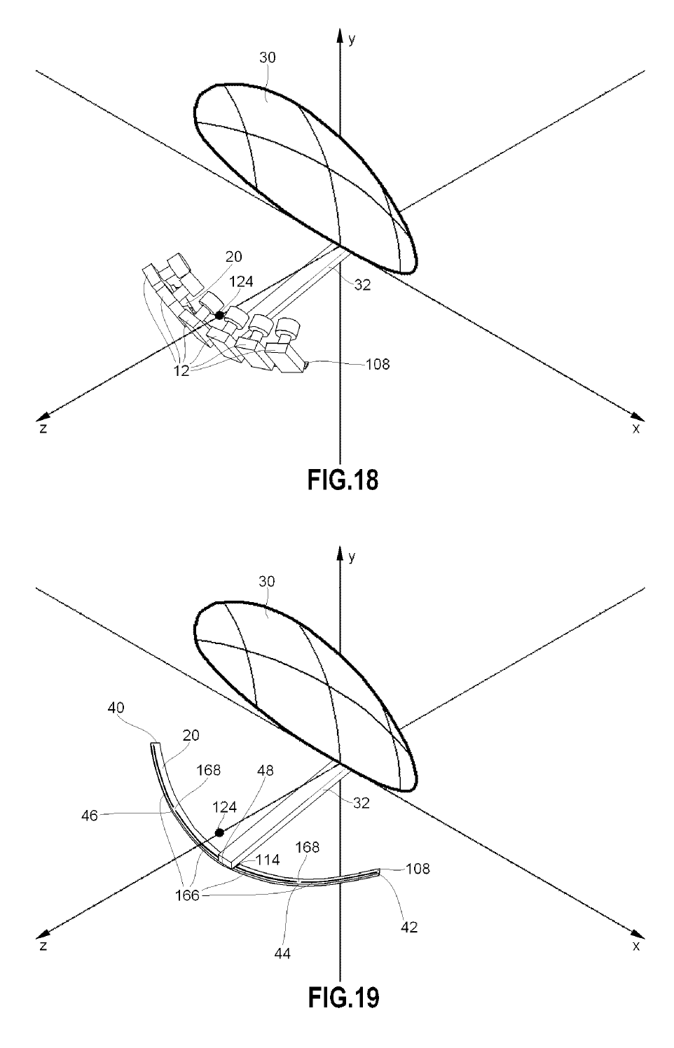

FIG. 17 depicts the main body of an LNB alignment device 20 with mounting holes 164 which are designed to hold the LNBs shown in FIGS. 8, 9 and 10. This LNB alignment device attaches to the bottom of the support arm 32 and utilizes a sloped component 114 to tilt the main body 108 in toward the paraboloid reflector 30. The focus of the reflector's paraboloid 124 is shown to give an approximate scale of the LNB alignment device. FIG. 18 depicts the same alignment device with LNBs 12 bolted in place via the mounting holes 164.

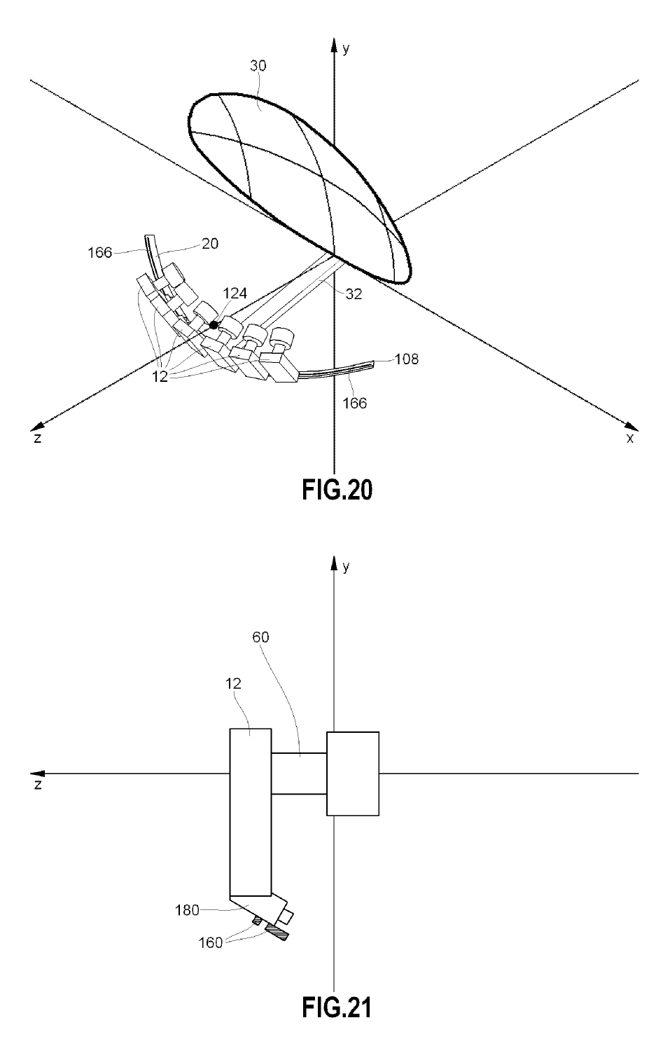

FIG. 19 depicts the main body 108 of an LNB alignment device 20 with slots 166 which allow the LNBs, shown in FIGS. 8, 9 and 10, to be positioned in multiple locations along the main body 108. FIG. 20 depicts the main body 108 with LNBs bolted to the slot 166. To strengthen the main body 108, it is preferable to have a break 168 in the slot 166 in the middle 48 of the main body 108, at the ends 40, 42 of the main body 108 and at a convenient point 44, 46 in between the middle and end of the main body 108. In the embodiment depicted, the “convenient points” 44, 46 in between the middle and end of the main body 108 are equidistantly spaced around the circumference of the main body 108. FIG. 21 is a side view of an LNB 12 with a main body cross section 160 of an LNB alignment device with slots. The LNB's base 180 will be bolted to the slot which is shown as a gap in the main body cross section.

In the embodiments depicted in FIGS. 13-20, the main body 108 is preferably marked with indicia such as numbers and ticks that indicate the angle about the reflector's y-axis of the source vector that corresponds to that location on the main body 108. Similarly, the neck clamps 162 are preferably marked with indicia (e.g., symbols, ticks and alphanumeric characters) that indicate feed horn skew settings.

Given the geographic location where the satellite dish will be installed and the set of satellites that will be sources, the location of each moveable LNB neck clamp 162 on the main body 108 can be calculated using “Method to Position One LNB Along the Feed Horn Curve” set forth below.

The manufacturer or retailer may form the mounting holes 164 in the main body 108 for the installer or may provide a list of mounting hole locations (or neck clamp 162 locations) to the installer to be made in the field at the time of installation. The appropriate dish alignment settings can be provided to the installer, however, these dish alignment settings will be apparent to those skilled in the art. As will be apparent, the feed horn skew is not adjustable in the case of the mounting holes 164 depicted in FIG. 17 and the slots 166 depicted in FIG. 19, but is adjustable in the case of the neck clamps 162 depicted in FIGS. 13-16.

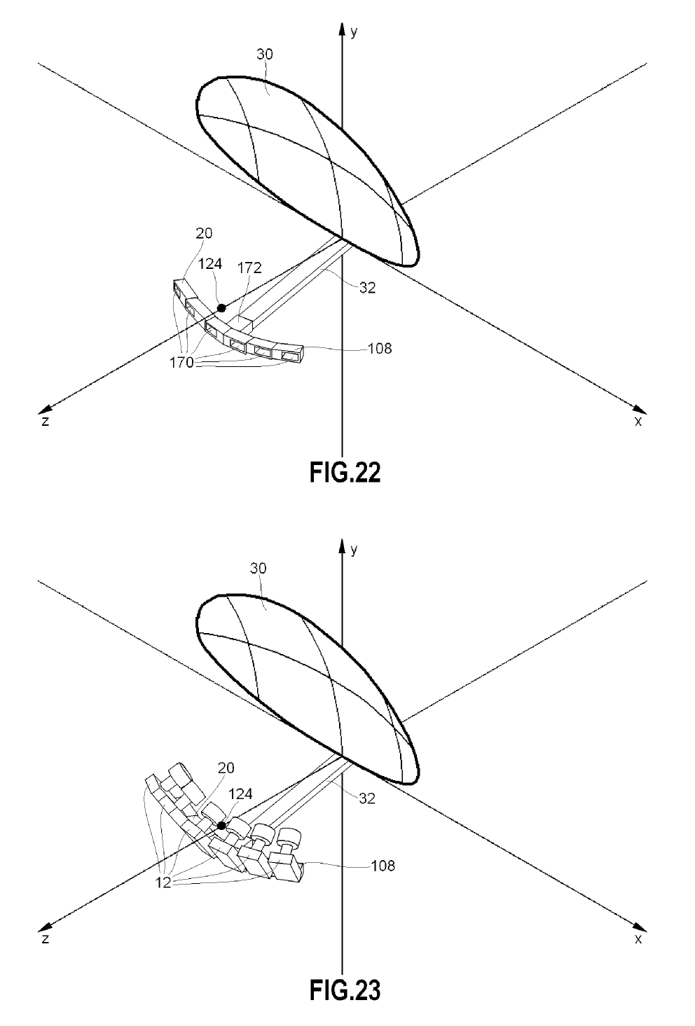

FIG. 22 depicts the main body of an LNB alignment device 20 with sleeves 170 which allow the rectangular bases 180 of the LNBs 12, shown in FIGS. 8, 9 and 10, to be inserted. FIG. 23 depicts the main body 108 with LNBs 12 in place.

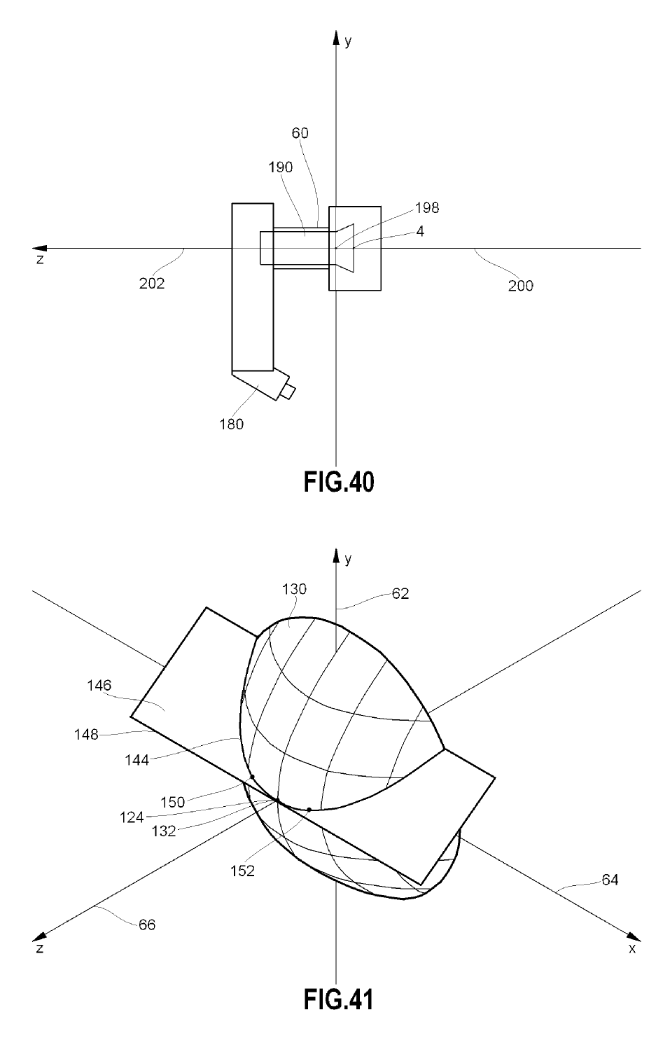

It is preferable to position, aim and skew the feed horns according to “Method to Position Multiple Fixed Feed Horns.” Each LNB's position, aim and skew are determined by the feed horn 190 that it contains, shown in FIGS. 39 and 40. The base 180 of each LNB 12 defines the position and orientation of the fixed yoke's rectangular sleeves 170. The main body 108 will preferably also have a support arm sleeve 172 for the support arm 32 shown in FIG. 12.

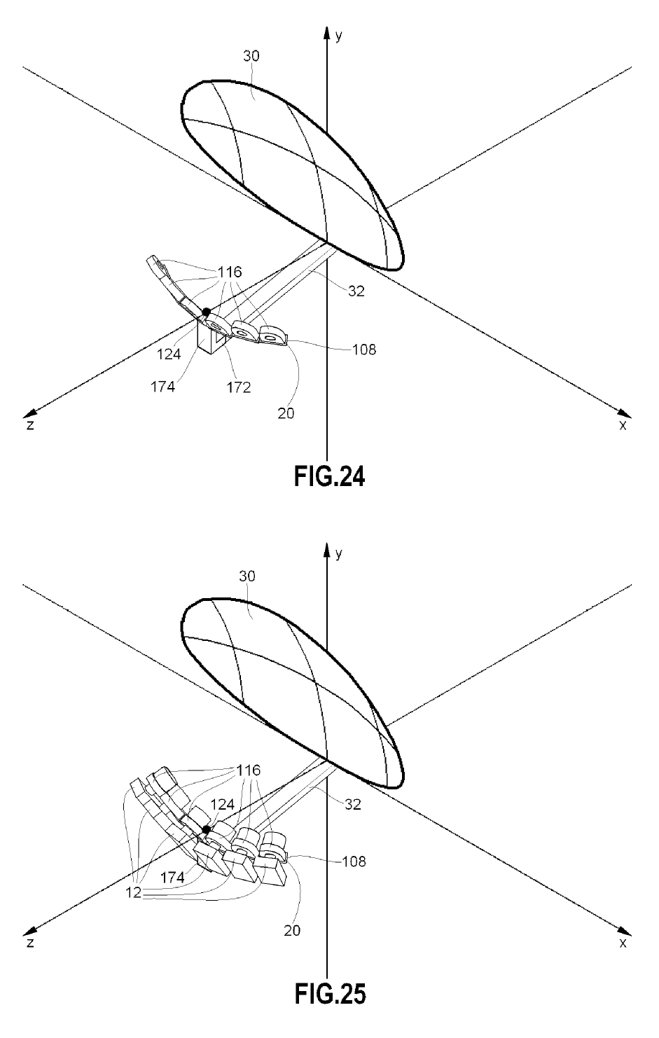

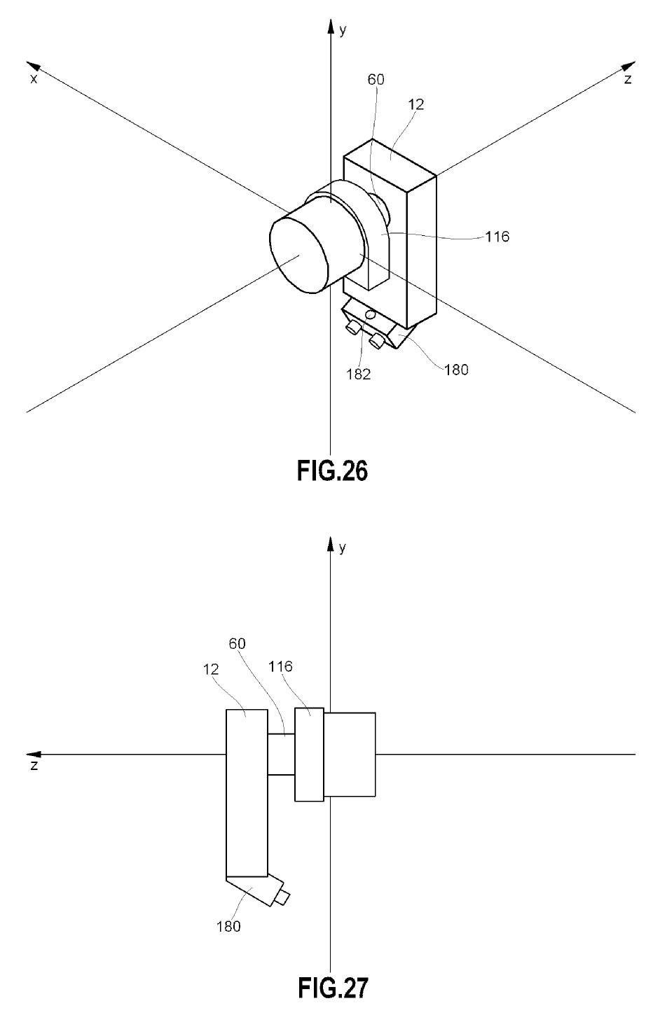

FIG. 24 depicts the main body 108 of an LNB alignment device 20 with fixed neck clamps 116, shown in FIGS. 26 and 27, which are designed to hold the necks 60 of LNBs. FIG. 25 depicts the main body 108 with LNBs fastened in place by the fixed neck clamps 116. Figure depicts a perspective front view of an LNB 12 with a fixed LNB neck clamp 116 around the LNB neck 60. FIG. 27 depicts a side view of an LNB with a neck clamp. As will be apparent to a skilled user, the LNB base and mounting hole are not required for securing the LNB to the main body 108 when using the neck clamp.

It is preferable to position, aim and skew the feed horns according to “Method to Position Multiple Fixed Feed Horns.”

Referring to FIG. 24, the embodiment depicted is substantially the same as shown and described with respect to the embodiment depicted in FIG. 1 with the exception that LNB clamps 116 are provided which fit around the necks of LNBs so that both common and uncommon LNBs 12 may be attached. Additionally, indicia, such as company logos, symbols, etc. may be imprinted, embossed or affixed (via adhesive or mechanical fastener) on the exterior of the main body or feed horns, such as for advertising or other purposes. Indicia, such as height markings or measurements, or labeling of the angles of the feed horns may also be imprinted, embossed or affixed (via adhesive or mechanical fastener) on the exterior of the main body or feed horns.

In one aspect, the main body may include height indicia to identify the resulting height and/or angle the feed horn will be set above the center of the satellite. Such height/angle indicia may include, but is not limited to, a visible height/angle identification marker and/or a tactile height/angle identification marker. By way of illustration, a visible height/angle identification marker includes an alphanumeric reference (e.g., 1, 2, 3 or A, B, C, and the like) or a measurement (e.g., ½ inch, 5 millimeters, 20 degrees, or the like). Other exemplary visible height/angle identification indicia includes a color-coded system where the entire main body or a portion of the main body is marked with a number, letter, or color which corresponds to the particular height/angle the feed horn will be placed above the center of the satellite dish using that receptacle (mounting hole or sleeve). Another exemplary tactile height/angle identification system includes a system where the main body is marked with indentations, detents, surface patterns, or the like which corresponds to the particular height/angle the feed horn will be placed above the center of the satellite dish using that receptacle of the main body. According to an exemplary embodiment, indicia may include both a visible and tactile height/angle identification system using colored receptacles.

It is preferable to use neck clamps 116 with an inner diameter of 40 millimeters to accommodate most LNBs. A removable ring with an outer diameter of 40 millimeters and an inner diameter of 30 millimeters may be used inside the neck clamps 116 to accommodate an LNB with a 30 millimeter neck 60. It is to be appreciated that neck clamps 116 of any size may be used and these dimensions are merely illustrative of some of the more common sizes of LNB necks 60 that will be encountered.

Each LNB's position, aim and skew are determined by the feed horn 190 that it contains, shown in FIGS. 39 and 40. In turn, the neck 60 of each LNB defines the position and orientation of the fixed neck clamps 116 and the main body 108 will support these positions. The main body 108 will also have a support arm sleeve 172 for the support arm 32 shown in FIG. 12.

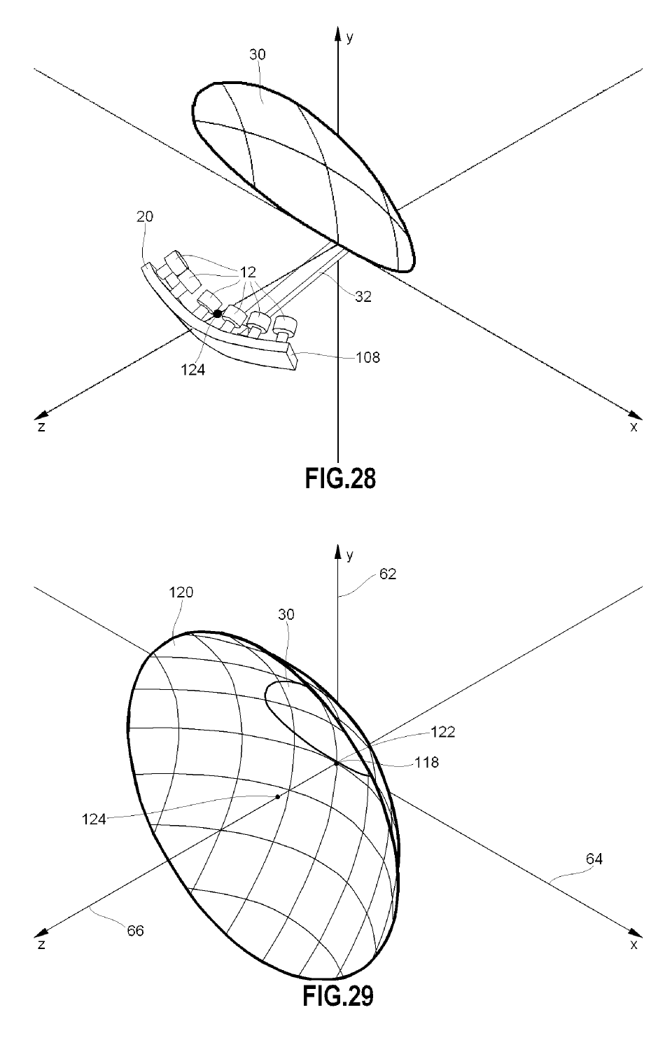

FIG. 28 depicts the main body of an LNB alignment device 20. In this embodiment of the alignment device 20, the LNBs 12 (shown in FIGS. 8, 9 and 10) are contained within the main body 108. The size of each LNB 12 may be reduced by configuring the LNBs 12 to share some electronic resources in a central location. In this arrangement, each LNB 12 may omit an individual plastic shell because the main body 108 will provide a plastic shell over all of the LNBs 12 collectively.

Referring to FIG. 28, the LNB alignment device 20 is a unitary device comprising the main body 108 and permanently affixed feed horns 12 such that feed horns cannot be added or removed. As previously described with respect to other embodiments, a support arm sleeve 172 attaches to the support arm 32 of an existing satellite dish and positions feed horns about the satellite dish. This embodiment requires very little setup work and is ideal for a one-time conversion of an existing satellite dish. The unitary device may be equipped with internal electronic switches that allow satellite receivers to select LNBs rather than relying on external switches.

It is preferable to position, aim and skew the feed horns 190 according to “Method to Position Multiple Fixed Feed Horns.” Each LNB's 12 position, aim and skew are determined by the feed horn 190 that it contains (shown in FIGS. 39 and 40). The plastic shell of the main body 108 will hold each LNB 12 in place. The main body 108 preferably will also have a sleeve (not visible in this view but see 172 of FIG. 22) for the support arm 32 (shown in FIG. 12). Inner coaxial cables for each LNB will routed through the main body 108 and will attach to coaxial connectors that protrude below the support arm 32.

In another embodiment (not depicted), the main body 108 consists of the combination of two or more main body portions. These main body portions are designed, for example, for different aim locations, geostationary locations, reflectors, virtual reflection points, LNB types, geographic locations, or other variations. It is preferred that the combined main body's shape is the average of the main body portions and comprises receptacles for each of the other main body portions. This embodiment allows an installer to have one multi-purpose LNB alignment device with several possible applications and configurations.

In one embodiment depicted in FIG. 1, an LNB alignment device 20 comprises a main body 108 in the form of bar-like member that removably attaches to a support arm 32 of a satellite dish and has a plurality of mounting holes 164 configured to receive a plurality of low-noise block converters with feed horns (LNBs). In one aspect, the main body 108 comprises a ⅛-inch by 1-inch bar with the curved contours described herein. Each LNB is preferably affixed to a mounting hole 164 using a mechanical fastener such as a bolt. In the embodiment depicted, each LNB is attached by its base 180 using a single bolt which passes through a mounting hole 164 in the bar 108 (main body). The use of mounting holes 164 and bolts allow LNBs to be selectively added or removed as necessary.

An LNB alignment device 20 comprises a main body 108o that removably attaches to a support arm 32 of a satellite dish and has a plurality of receptacles 164 configured to receive a plurality of low-noise block converters with feed horns (LNBs). In one aspect, the receptacle 164 comprises a rectangular sleeve 170 that allows the base of an LNB to be inserted into the sleeve 170. This design is sturdier than a simple bar and may be formed of an inexpensive material such as plastic.

Preferably, all or most of the feed horns affixed to the main body 108 are disposed greater than 10 degrees from the focal axis. In the embodiment depicted, there are provided a series of six sleeves 170. Each sleeve 170 has a rectangular cross section and comprises a channel whose profile accommodates and generally conforms to the base 180 of an LNB with a rectangular base which is commonly 19 millimeters high and 45 millimeters wide. In one preferred embodiment, the bases of the sleeves 170 are the main body 108 and each sleeve 170 is about 75 millimeters deep at its deepest point. In using the LNB alignment device 20, a satellite installer (user) preferably places an LNB in the sleeve 170 such that at least one half, and more preferably, at least two thirds, of the feed horn is above the crown of the sleeve 170 when mounted on the main body 108.

In one aspect of the embodiment illustrated and described with respect to FIG. 22, the receptacle sleeves 170 are modified to allow LNBs with dome-shaped bases to be inserted as well.

In another embodiment (not depicted), the LNB alignment device 20 makes use of its own mechanism to attach the main body 108 (e.g., bar) directly to the reflector of the satellite dish. This is useful in the case of satellite dishes which have a weak support arm 32 or a support arm 32 that does not allow an alignment device 20 to be easily bolted to it.

In the embodiment depicted in FIG. 17, the main body 108 is designed to cooperate with a specific model or type of satellite receiver. The mounting holes 164 are disposed in a series of predetermined positions that will place the opening of each feed horn in a focal area of a satellite signal from a specific known geostationary location. Thus, someone in a particular city could purchase an LNB alignment device 20 that is designed to accommodate the satellite signals that are typically available or desired in that city.

In a similar embodiment (not depicted), the LNB alignment device affixes one or more LNBs to the main body 108 and makes use of a motor or other mechanism to move and position the LNBs along the main body 108. The motor or other mechanism may be controlled by a satellite receiver or radio frequency receiver.

Other embodiments of the present invention comprise one or more of the features previously described in detail with respect to the embodiment depicted in FIG. 1. LNB alignment devices according to the present invention include adapters which modify the capabilities of existing satellite dishes. LNB alignment devices according to the present invention also include original equipment that comes with a satellite dish. One such LNB alignment device positions one LNB about a satellite dish reflector. Another such LNB alignment device positions two or more LNBs about a satellite dish reflector. Another such LNB alignment device positions three or more LNBs about a satellite dish reflector. Another such LNB alignment device positions four or more LNBs about a satellite dish reflector. Another such LNB alignment device positions five or more LNBs about a satellite dish reflector. Another such LNB alignment device positions six or more LNBs about a satellite dish reflector. Another such alignment device positions more than 10 LNBs about a satellite dish reflector.

It is preferred if the level line between LNB feed horns is within 10 degrees, and more preferably within 5 degrees, of parallel with the dish's x-axis, but it is not necessary.

Another embodiment of the present invention comprises unitary original equipment that makes use of more than five feed horns and/or receives signals from at least two orbital locations which are separated by 20 degrees. The level line is preferably within 5 degrees of parallel with the dish's x-axis, and it is preferred if the level line is parallel with the dish's x-axis. In one aspect of this embodiment, the dimensions of the main body are calculated for a specific geographic location.

Another embodiment of the present invention comprises original equipment that is not unitary in that LNBs are selectively added, removed, and/or repositioned.

Another embodiment of the present invention comprises receiving devices other than LNBs and additionally comprises one or more transmitting devices. By way of illustration, one or more wireless networking antennas are disposed about a reflector, where at least one wireless networking antenna is not along the reflector's focal axis. This allows each wireless networking antenna to be positioned so that it targets a specific, distant area.

Another such embodiment positions one or more television antennas about a reflector. This allows each television antenna to be positioned so that it targets a specific, distant area. This may be useful to users who are too far from a television broadcast location to receive signals from it using standard equipment. This may be especially useful as the transition is made from analog to digital broadcast television and users who currently receive and view analog television channels with low signal quality will not be able to receive digital television channels with sufficient quality to view the channel. In this aspect, an alignment device for holding a plurality of receivers in front of a paraboloid reflector. The alignment device comprising a main body having a fastening portion. The fastening portion is removably attachable in cooperation with the paraboloid reflector and the main body comprises a plurality of predetermined receptacles for mounting a plurality of receivers in a general side-by-side fashion. The main body comprises a generally arciformed shape whereby the plurality of predetermined mounting locations possess a non-planar configuration.

With respect to the satellite applications, the Alignment Device holds LNBs in front of a satellite receiver dish, is adapted to be received by a satellite dish assembly having a support arm. The fastening portion is removably attachable in cooperation with the satellite dish support arm and the main body comprises a plurality of predetermined receptacles for mounting LNBs.

Methods for Positioning LNB Feed Horns

These methods position one or more receiving devices in front of a paraboloid reflector 30 to receive signals from a source. These methods specifically apply to positioning feed horns in front of a satellite dish to receive signals from a satellites and are explained in reference to FIGS. 29-41.

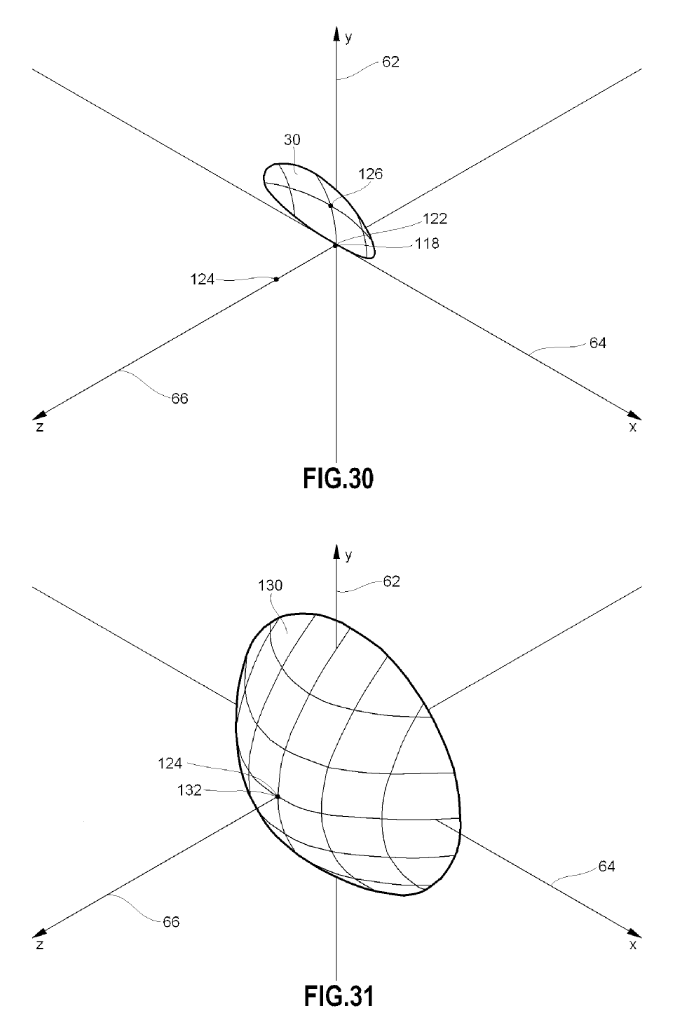

As depicted in FIG. 29, a satellite dish reflector 30 is essentially a paraboloid reflector 30 (“reflector”) and part of a circular paraboloid (or approximately so). This paraboloid is henceforth referred to as the “reflector's paraboloid” 120. Referring to FIG. 30, the reflector 30 is positioned in a coordinate system, which consists of an x-axis 64, y-axis 62, and z-axis 66, so that: the axis of the reflector's paraboloid 120 is along the z-axis 66, the reflector's paraboloid 120 opens toward the positive z-axis 66, and the vertex 122 of the reflector's paraboloid 120 is at the origin 118. All vectors in this specification are written in the form [x, y, z]. All points in this specification are written in the form (x, y, z).

If the reflector has a top, as is the case with offset satellite dishes, then the reflector's top will be above the xz-plane and along the yz-plane. (Otherwise, a point on the reflector 30 which is convenient may act as the top.) With the reflector 30 positioned as described above, the “reflector's center point” 126 (see FIG. 30) is the point along the reflector 30 whose y value is the average of the reflector's 30 lowest y value and the reflector's 30 highest y value and whose x value is the average of the reflector's 30 lowest x value and the reflector's 30 highest x value.

For example, if the reflector's 30 lowest y value is 50 millimeters, highest y value is 550 millimeters, lowest x value is −250 millimeters, and highest x value is 250 millimeters, then the center point's 126 y value is 300 millimeters and the center point's 126 x value is 0 millimeters. The reflector's center point 126 is shown in FIG. 30.

The point f_{d} is the focus of the reflector's paraboloid 120. The distance p_{d} is the focal length of the reflector's paraboloid 120. Referring to FIG. 31, the “receiver paraboloid” 130 is a circular paraboloid which opens toward the origin (118 of FIG. 30) and whose axis is along the z-axis 66. The preferred location of the receiver paraboloid's vertex 132 is at the point f_{d}. Placing the receiver paraboloid's vertex between z=0.6p_{d} and z=1.6p_{d} is within the acceptable range but is less useful. The preferred focal length of the receiver paraboloid is

$$\frac{2}{3} {p}_{d} .$$

A receiver paraboloid having a different focal length between 0.3p_{d} and 6.3p_{d} is within the acceptable range but is less useful.

The earth location where a satellite dish is located will be referred to as the “geographic location”. The earth's geostationary orbital locations form a ring (“geostationary ring”) around the earth above the equator. These geostationary orbital locations are identified by their longitude. In this specification a number in degrees followed by a “W” will mean that many degrees west longitude and a number in degrees followed by an “E” will mean that many degrees east longitude. For example 82° W means 82° west longitude. The geostationary orbital location that a satellite dish will aim at will be referred to as the “aim location”. When the satellite dish is said to be aimed at an aim location this means that the positive z-axis of the reflector's paraboloid will intersect the aim location When the satellite dish is said to be skewed for an aim location this means that the x-axis of the reflector's paraboloid is parallel to the line which: intersects the aim location, is tangential to the geostationary ring, and is along the plane of the equator.

As used in this specification, feed horn skew (when a feed horn that will receive satellite signals is said to be skewed for its source) means that the feed horn is rotated about its z-axis so that its x-axis is parallel to the line which: intersects the source's geostationary orbital location, is tangential to the geostationary ring, and is along the plane of the equator

Defining One Receiver Point and Positioning One Feed Horn

This is a method to position one receiving device in front of a paraboloid reflector 30 to receive signals from a source. This method specifically applies to positioning one feed horn in front of a satellite dish to receive signals from a satellite.

A receiver point (a position where a receiver should be located to receive signals from a source associated with the source vector) and a feed horn position at that receiver point are determined from three input data: a paraboloid satellite dish reflector 30, a feed throat inner diameter, and a source vector (a unit vector which is along a line from the origin to the source and whose initial point is at the origin as described below).

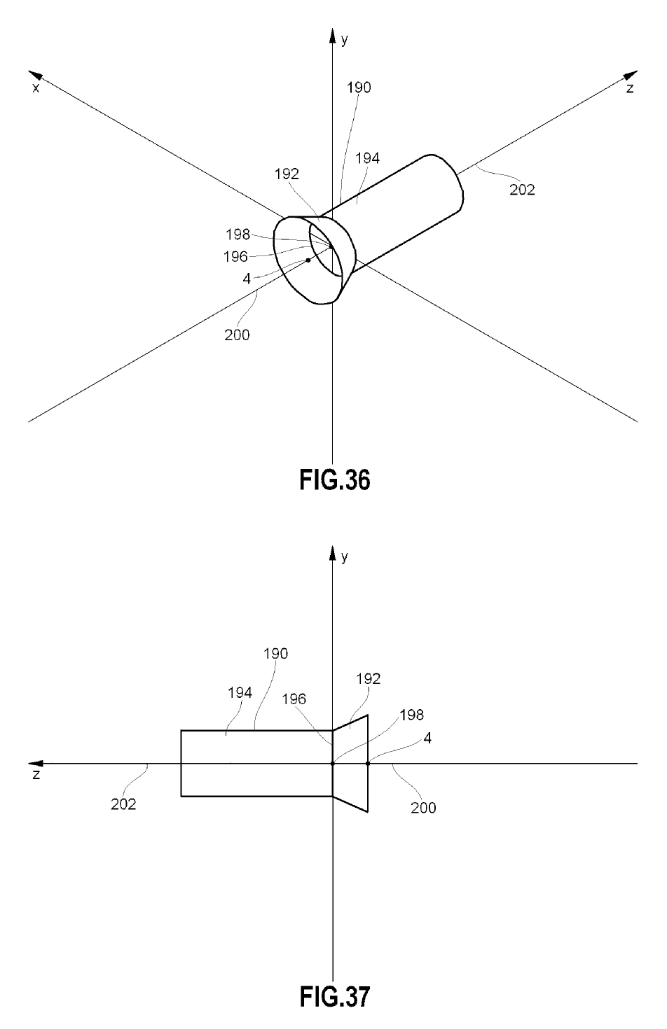

The distance h is the inside diameter of the feed horn's throat 196 (“feed throat”). The feed horn and its feed throat 196 are shown in FIGS. 36 and 37. In the rare case that the receiving device does not contain a feed horn, h is the aperture of the receiving device. FIG. 36 shows the feed horn 190, its waveguide 194, and its feed cone 192. The feed throat 196 is where the waveguide and feed cone join. The feed throat center 198 is the origin of the feed horn's coordinate system. The feed horn's z-axis passes through its center and is comprised of the positive z-axis 202 and negative z-axis 200. The feed horn opening point 4 is at the center of the feed cone along the feed horn's negative z-axis. FIG. 37 is a side view of the feed horn 190 and its components.

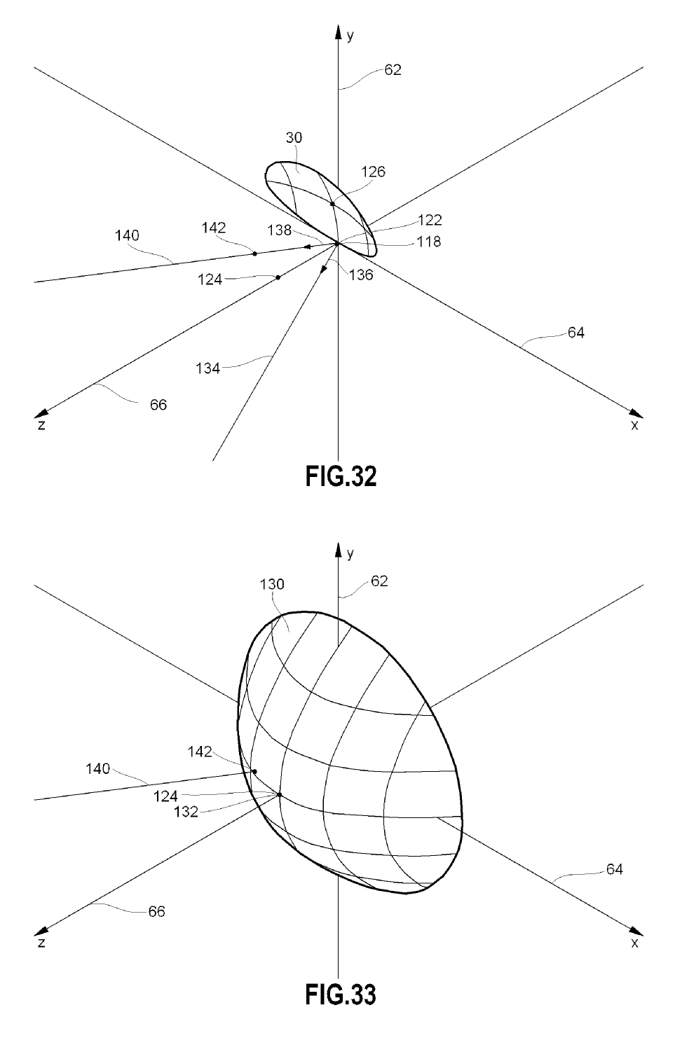

Referring to FIG. 32, for a given source the “source line” 134 is the line which intersects the origin and the source; θ_{z} as the positive angle between the source line and the z-axis; the “source vector” 136 as a unit vector which is along the source line and whose initial point is at the origin; the x, y, and z components of the source vector as xₛ, yₛ, and zₛ respectively; and finally the “resultant vector” 138 as a unit vector whose initial point is at the origin 118 and whose components are xᵣ, yᵣ, and zᵣ which are found using the following method.

Let w equal the number of degrees of θ_{z}. For example if θ_{z}=23.7° then w=23.7.

$Let {θ}_{h} = arctan ( \frac{0.5 h}{{p}_{d}} )$
If xₛ ≠ 0

$let {θ}_{f} = arctan ( \frac{{y}_{s}}{{x}_{s}} )$

If xₛ = 0

if yₛ > 0, let θ_{f} = 90°
if yₛ < 0, let θ_{f} = −90°
if yₛ = 0, let θ_{f} = 0°

If 0° ≦ θ_{z} < 5.5°

y₁ = 0
x₁ = sinθ_{z}

If 5.5° ≦ θ_{z} < 8°

y₁ = −0.0000439524w² + 0.00390643w − 0.019394
x₁ = sin(θ_{z}) · \sqrt{1 − y₁²}

If 8° ≦ θ_{z} < 44°

y₁ = −0.0000439524w² + 0.00390643w − 0.019394
x₁ = −0.000112256w² + 0.0198675w − 0.00267343

If 44° ≦ θ_{z} < 90°

y₁ = 0.0674
x₁ = −0.000112256w² + 0.0198675w − 0.00267343

z₁ = \sqrt{1 − x₁² − y₁²}
$If arctan ( \frac{{x}_{1}}{{z}_{1}} ) \geq {θ}_{h}$

z₂ = z₁ cos(θₕ) − x₁ sin(θₕ)
x₂ = z₁ sin(θₕ) + x₁ cos(θₕ)

$If arctan ( \frac{{x}_{1}}{{z}_{1}} ) < {θ}_{h}$

z₂ = z₁
x₂ = x₁

If xₛ ≧ 0

x₃ = −x₂

If xₛ < 0

x₃ = x₂

xᵣ = x₃ cos(θ_{f}) − y₁ sin(θ_{f})
yᵣ = x₃ sin(θ_{f}) + y₁ cos(θ_{f})
zᵣ = z₂

Referring to FIG. 32, the “resultant line” 140 is the line which intersects the origin 118 and the resultant vector 138. Referring to FIGS. 32 and 33, the “receiver point” 142 is the point where the resultant line 140 intersects the receiver parabola 130.

To position a feed horn to receive signals from the source, the feed throat 196 center 198 is placed at the receiver point 142 and the feed horn is aimed so that its negative z-axis 200 intersects the reflector's center point 126.

Method to Position Multiple Fixed Feed Horns

This method is best used for a satellite dish at a specific geographic location that is intended to receive signals from several specific geostationary sources. The feed horns are fixed relative to the satellite dish 30 and do not require adjustability. This method incorporates the previously described method for “Defining One Receiver Point and Positioning One Feed Horn.” A feed horn position for each geostationary source for each of several feed horns 190 is determined from four input data: a specific geographic location, the feed throat 196 inner diameter, several specific geostationary source locations (e.g. geostationary satellites), and the geographic location where the satellite dish 30 is located.

This method is for a satellite dish 30 at a specific geographic location that is intended to receive signals from several specific geostationary sources. It is preferable to select the “aim location” as the geostationary orbital location that is half way between the eastern most and western most geostationary source. For example if 82° W is the geostationary orbital location of the eastern most source and 129° W is the geostationary orbital location of the western most source, then it is preferable to select 105.5° W as the aim location.

Calculating the “source vector” 136 of each geostationary source will be apparent to those skilled in the art, given the geographic location, aim location, the source's geostationary orbital location, and that the satellite dish is aimed at the aim location and skewed for the aim location.

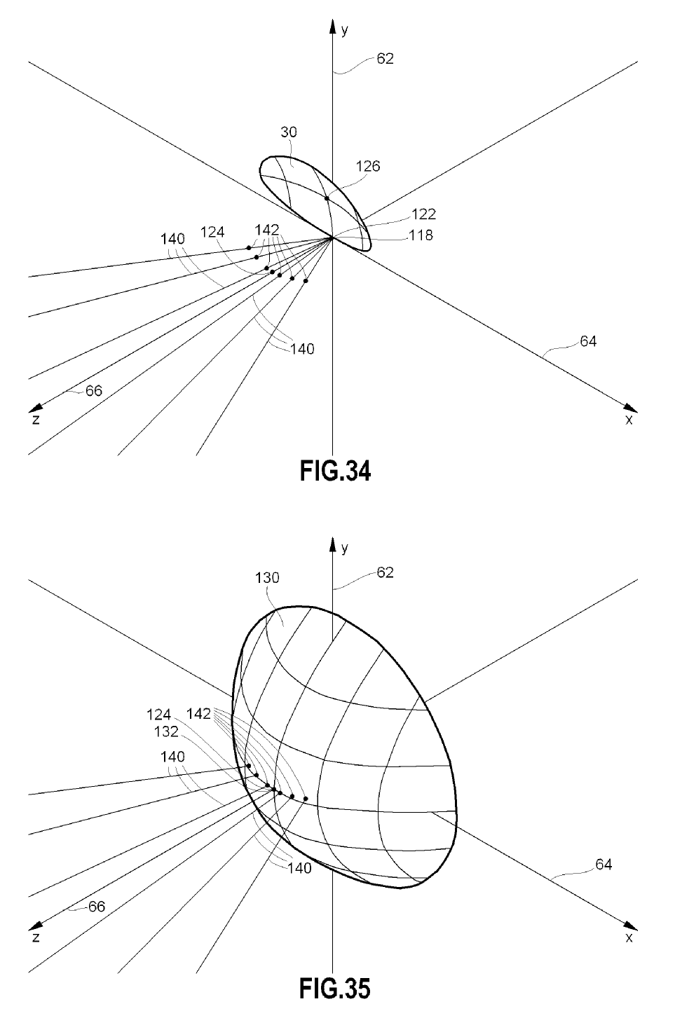

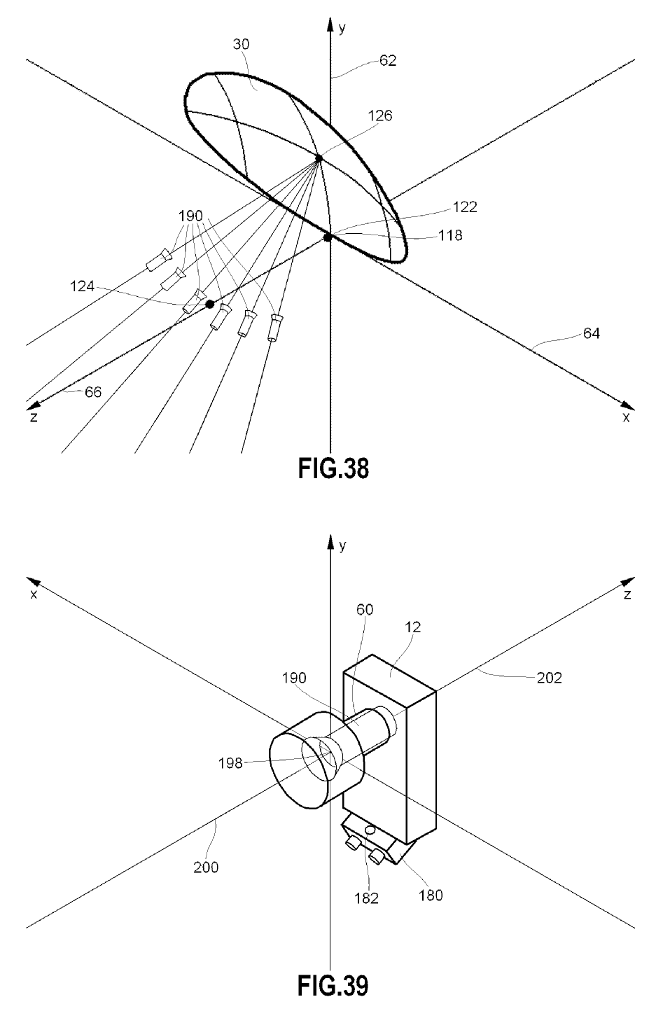

Referring to FIGS. 34 and 35, for a given satellite dish 30 and inner feed throat diameter, each source vector 136 is used to calculate the receiver point 142 for each source using the “Method to Define One Receiver Point and Position One Feed Horn”. Each feed horn 190 is positioned and aimed and skewed for its source according to that method as depicted in FIG. 38.

For example, if the dish's geographic location is 40° N and 85.5° W and the geostationary orbital locations of the sources are 82° W, 91° W, 101° W, 110° W, 119° W, and 129° W, the dish will be aimed and skewed for the aim location 105.5° W. For this example, the feed throat's inner diameter is 17 millimeters. The source vector 136 for the source at 82° W is [0.44350, −0.01007, 0.89622]. The resultant vector 138 for the source at 82° W is [−0.45822, 0.06342, 0.88657]. For this example, the satellite dish's focal length is 449 millimeters, the focal length of a preferred receiver paraboloid 130 is approximately 299.33 millimeters, and the receiver point 142 for the source at 82° W is (−212.25 millimeters, 29.37 millimeters, 410.66 millimeters). The position and aim of each feed horn 190 in this example are depicted in FIG. 38. FIG. 38 shows the feed horns aiming at the reflector's center point 126. The vertex of the reflector's paraboloid 122 at the origin 118 and the focus of the reflector's paraboloid 124 are also shown.

Method to Define a Feed Horn Curve for Multiple Movable Feed Horns

When a user has a specific satellite dish at a specific latitude, this method may be used to determine a feed horn curve (the feed horn curve defines many possible positions for feed horns) and a feed horn plane (the plane on which the feed horn curve is along). The longitude of the geographic location and the geostationary orbital locations of the sources do not need to be specified. Embodiments that utilize the feed horn curve are more versatile than the previously mentioned fixed embodiments and have a simpler shape, because they are derived from a simple curve along a plane.

A feed horn curve is determined from two input data: the latitude of the geographic location and the feed throat inner diameter. This method incorporates the previously described method for “Defining One Receiver Point and Positioning One Feed Horn.”

As depicted in FIG. 41, this method defines a “feed horn curve” 144 and a “feed horn plane” 146. The feed horn curve 144 is elliptical or parabolic and is along the feed horn plane 146. This can be accomplished so that for a specific satellite dish at a specific latitude, the receiver points which correspond to geostationary orbital locations are nearly intersected by the feed horn curve 144. The longitude of the geographic location and the geostationary orbital locations of the sources do not need to be specified to define the feed horn curve 144.

For a specific satellite dish at a specific latitude, where the satellite dish is aimed at and skewed for a geostationary orbital location, each position along the feed horn curve 144 will correspond to a geostationary orbital location. In other words, a feed horn 190 slid along the feed horn curve 144 will closely follow the geostationary ring.

The preferred method to define the feed horn curve follows. The “Method to Define One Receiver Point and Position One Feed Horn” is used to calculate “receiver point A” 150 and “receiver point B” 152 given the following data: the geographic location of the satellite dish is 0° W longitude and at the specified latitude, the aim location is 30° W, the source for receiver point A is 5° W and the source for receiver point B is 55° W, and the satellite dish is aimed at the aim location and skewed for the aim location.

Calculating the source vectors for receiver point A and receiver point B will be apparent to those skilled in the art given the previous data. The data is only used for calculation and does not literally require that a satellite dish and sources be positioned as described.

The “feed horn plane” 146 is the plane that: is parallel to the x-axis 64, intersects the vertex of the receiver paraboloid 132, and is rotated about its intersection with the xz-plane 148 so that the feed horn plane 146 is an equal distance between receiver point A 150 and receiver point B 152. The crossing of the feed horn plane 146 with the receiver paraboloid 130 defines the needed elliptical or parabolic feed horn curve 144.

Method to Define a Main Body Using a Feed Horn Curve

The shape of the main body 108 is calculated with 4 data inputs: the feed horn curve 144 (FIG. 41), the feed horn plane 146 (FIG. 41), the main body 108 cross section 160 as positioned relative to an LNB (seen in FIGS. 11, 16 and 21), and the satellite dish's center point 126.

Referring to the embodiments depicted in FIGS. 13, 17, and 19, the shape of the main body 108 is determined by sliding an LNB containing a feed horn 190 along the feed horn curve 144.

FIG. 39 depicts the position of a feed horn 190 within an LNB 12. The feed horn's z-axis passes through its center and is comprised of the positive z-axis 202 and negative z-axis 200. The feed throat center 198 is the origin of the feed horn's coordinate system. The LNB's base 180 and mounting hole 182 are generally oriented downward. FIG. 40 is a side view of the position of a feed horn within an LNB which is described in FIG. 39.

FIGS. 11, 16 and 21 show main body cross sections 160. Each figure shows different dimensions and positions of the main body cross section suitable for different embodiments. As the LNB is slid along the feed horn curve 144, the main body cross section 160 traces the shape of the main body 108.

It is preferable to trace a main body 108 which is relatively simple. To that end, the LNB shall be slid along the feed horn curve 144 which is along the feed horn plane 146 and the LNB shall maintain fixed angles with the feed horn plane 146. The details of this procedure are as follows.

The “feed horn x-angle” is the angle between the feed horn plane and a line from the focus to the satellite dish's center point. When the LNB is slid along the feed horn curve 144: the feed throat center 198 shall remain along the feed horn curve 144, the feed horn's x-axis shall remain along the feed horn plane 146, the feed horn's x-axis shall remain tangential to the feed horn curve 144, and the feed horn's negative z-axis shall remain at the x-angle with the feed horn plane 146. The preferred point to start sliding the LNB is the point on the ellipse that is at an angle of −55 degrees about the y-axis 62 from the yz-plane. The preferred point to stop sliding the LNB is the point on the ellipse that is at an angle of 55 degrees about the y-axis 62 from the yz-plane.

For embodiments that use the feed horn curve 144, it is acceptable and common for a feed horn's negative z-axis not to intersect the dish's center point 126 as described in the “Method to Define One Receiver Point and Position One Feed Horn”.

Method to Position One LNB Along the Feed Horn Curve

The position for one LNB along the feed horn curve 144 is determined with three data inputs: the feed horn curve 144, the feed horn plane 146 and the source vector 136. This method incorporates the previously described “Method to Define One Receiver Point and Position One Feed Horn” to calculate the receiver point 142.

The “feed horn x-angle” is the angle between: the feed horn plane 146 and a line from the focus to the satellite dish's center point 126. The feed throat center 198 of the LNB's feed horn 190 (FIGS. 39 and 40) will be placed: along the feed horn curve 144 and as close as possible to the receiver point 142. The feed horn's x-axis will be along the feed horn plane 146, the feed horn's x-axis will be tangential to the feed horn curve 144, and the feed horn's negative z-axis will be at the x-angle with the feed horn plane 146.

Materials and Manufacturing Methods

The LNB alignment device is preferably constructed from a material that holds its shape. The LNB alignment device is preferably sturdy, but can also be pliable, as long as the LNB alignment device provides sufficient structural integrity to support the pressures exerted on it during its use. According to one embodiment, the LNB alignment device is moisture repellant or resistant, such that it resists corrosion from exposure to the elements and changes in size. The LNB alignment device is constructed of a material such as wood, metal, metal alloy, metallic material, plastic, combinations and/or mixtures thereof. An exemplary material of the LNB alignment device is a molded or bent metal or metal alloy. An exemplary material of the LNB alignment device is a moldable thermoplastic such as nylon or polypropylene. The LNB alignment device may be of unibody design, i.e., it is formed from a single piece of material with no moving parts.

On one aspect, the LNB alignment device is manufactured by an injection molding process with a thermoplastic. Preferably, the thermoplastic comprises from about 5% to about 50%, preferably from about 10% to about 33% (by volume), of a filler such as fiberglass to reduce shrinkage and/or increase strength.

The LNB alignment device may also be formed from separate components. An exemplary embodiment of the LNB alignment device formed from separate or multiple components is an embodiment where the length of main body is adjustable (such as telescoping). Another example is the unitary device (comprises the LNB feed horns permanently affixed to the main body) where each component is separately manufactured and then assembled for use.

As such, those skilled in the art will appreciate that the conception, upon which this disclosure is based, may readily be utilized as a basis for the designing of other structures for carrying out the several purposes of the present invention. It is important, therefore, that the invention be regarded as including such equivalent construction insofar as they do not depart from the spirit and scope of the conception regarded as the present invention.

I claim:

1. An LNB Alignment Device comprising a main body that
removably attaches to a satellite dish having a focal axis, and
has a plurality of receptacles that receive a plurality of low-noise block converters with feed horns wherein at least two low-noise block converters with feed horns are disposed outside of the focal axis, and
is generally arciformed in shape and positions the feed horns generally side-by-side in front of the satellite dish and positions the feed horns outside of the focal axis at the same height or progressively higher along an inward curve that opens toward the satellite dish and aims the feed horns at the satellite dish

2. The LNB Alignment Device of claim 1 wherein the main body is configured to simultaneously receive greater than five low-noise block converters with feed horns.

3. The LNB Alignment Device of claim 1 wherein the main body attaches to a satellite dish at a support arm thereof.

4. The LNB Alignment Device of claim 1 wherein the feed horns are positioned to aim at a center of the satellite dish.

5. The LNB Alignment Device of claim 1 wherein the plurality of receptacles position the feed horns at a uniform distance from the center of the reflector of the satellite dish.

6. The LNB Alignment Device of claim 1 wherein the plurality of receptacles are disposed at a predetermined position to place an opening of the feed horns in a focal area of a satellite signal from a geostationary orbital location.

7. The LNB Alignment Device of claim 6 wherein the plurality of receptacles position the feed horns to receive a plurality of signals from a plurality of geostationary orbital locations wherein at least two of the geostationary orbital is locations are greater than 20 degrees longitude apart.

8. The LNB Alignment Device of claim 1 wherein the plurality of receptacles are selectively adjustable to position the feed horns such that an opening of the feed horns is in a focal area of a satellite signal from a geostationary orbital location.

9. The LNB Alignment Device of claim 1 wherein the plurality of receptacles cooperate with an adjustable attachment mechanism of the low-noise block converters with feed horns such that the feed horns are adjustable in a manner to position an opening of the feed horns along a curve that intersects a plurality focal areas of a plurality of satellite signals.

10. The LNB Alignment Device of claim 1 wherein the main body positions a first low-noise block converter at a first end of the main body and a second low-noise block converter at a second end of the main body such that a line from a first top edge of the first low-noise block converter to a second top edge of the second low-noise block is within 10 degrees of parallel with an x-axis of a reflector of the satellite dish wherein the reflector has a paraboloid shape and is positioned in a coordinate system where a z-axis is along a boresight axis of the satellite dish, a y-axis is a vertical axis of the satellite dish and the x-axis is a horizontal axis of the satellite dish.

11. The LNB Alignment Device of claim 10 wherein a line from the first top edge of the first low-noise block converter to the second top edge of the second low-noise block is within 5 degrees of parallel with the x-axis of the reflector of the satellite dish.

12. The LNB Alignment Device of claim 1 wherein the satellite dish has a paraboloid shape positioned in a coordinate system consisting of an x-axis, a y-axis, and a z-axis is along a boresight axis, the y axis is a vertical axis of the satellite dish, and the x-axis is a horizontal axis of the satellite dish and wherein the plurality of receptacles receive a first low-noise block converter with a first feed horn and a second low-noise block converter with a second feed horn such that the first and second feed horns are disposed in front of the satellite dish such that the second feed horn is disposed farther from the focal axis than the first feed horn, and the second feed horn is disposed closer to the x-axis and higher above an xz-plane than the first feed horn.

13. An LNB Alignment Device having a main body that
removably attaches to a satellite dish having a focal axis, and
has a plurality of receptacles that receive greater than five low-noise block converters with feed horns,
positions the feed horns side-by-side in front of the satellite dish and positions the feed horns outside of the focal axis progressively higher along an upward and inward curve that opens toward a receiver of the satellite dish and aims the feed horns to aim at the reflector of the satellite dish, wherein the upward and inward curve of the main body enables an opening of the feed horns receiving a satellite signal from a geostationary orbital location disposed to the east or west of the center to be disposed in a focal area of a satellite signal, and
wherein the plurality of receptacles position the feed horns to receive a plurality of signals from a plurality of geostationary orbital locations wherein at least two of the geostationary orbital locations are greater than 20 degrees longitude apart.

14. The LNB Alignment Device of claim 13 wherein the plurality of receptacles are disposed at a predetermined position to place an opening of the feed horns in a focal area of a satellite signal from a geostationary orbital location thereby allowing a user to easily position feed horns in an optimal configuration.

15. The LIB Alignment Device of claim 13 wherein the plurality of receptacles dispose the feed horns such that an opening of the feed horns is along a curve that
opens toward the reflector,
is disposed 60% to 160% of a focal length of the reflector away from a vertex of the reflector, and
whose radius of curvature is 30% to 630% the focal length of the reflector.

16. The LNB Alignment Device of claim 15 wherein the plurality of receptacles dispose the feed horns such that an opening of the feed horns is along a curve that
opens toward the reflector,
is disposed 90% to 110% of a focal length of the reflector away from the vertex of the reflector, and
whose radius of curvature is 120% to 140% the focal length of the reflector.

16. An Alignment Device for holding a plurality of receivers in front of a paraboloid reflector, the alignment device comprising a main body having a fastening portion, wherein the fastening portion is removably attachable in cooperation with the paraboloid reflector, wherein the main body comprises a plurality of predetermined receptacles for mounting a plurality of receivers in a general side-by-side fashion, and the main body comprises a generally arciformed shape whereby the plurality of predetermined mounting locations possess a non-planar configuration.

17. The Alignment Device of claim 16 wherein the alignment device holds LNBs in front of a satellite receiver dish, is adapted to be received by a satellite dish assembly having a support arm, wherein the fastening portion is removably attachable in cooperation with the satellite dish support arm, wherein the main body comprises a plurality of predetermined receptacles for mounting LNBs.
